(19) United States
(12) Patent Application Publication
(10) Pub. No.: US 2008/0140826 A1
(43) Pub. Date: Jun. 12, 2008

(54) Monitoring and controlling electronic message distribution

(75) Inventors: Charles McColgan, Kirkland, WA (US); Marc Levy, Woodinville, WA (US); Lance Galey, Sammamish, WA (US); Stephen Bolinger, Seattle, WA (US); Amit Jhawar, Redmond, WA (US); Todd Roman, Seattle, WA (US); Malcolm Erik Pearson, Kirkland, WA (US); Yi Liao, Sammamish, WA (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/684,929

(22) Filed: Mar. 12, 2007

Related U.S. Application Data
(60) Provisional application No. 60/869,248, filed on Dec. 8, 2006.

(51) Int. Cl. G06F 15/173

(52) U.S. Cl. 709/224

(57) ABSTRACT

A method for controlling a message distribution process comprising a series of coordinated processes by monitoring the performance of each process, determining that a monitored process is not processing properly, and skipping the process not processing properly. Another method for controlling the load of message traffic by determining the performance of a message server and altering the flow of messages based upon the determined performance of the message server. Another method for routing messages by identifying the addresses of senders of received messages, assigning a portion of the addresses to a category, and routing messages from the identified addresses according to their assigned category.

### BACKGROUND

Conventional electronic messaging systems route millions of e-mails per day from senders to recipients. The tasks associated with routing these millions of messages can be distributed among many discrete routing resources (e.g., hardware), such as message servers. As part of this electronic message routing process, the message servers of these electronic messaging systems perform routine checks on each of the many electronic messages to determine if they will modify, delete, archive, or otherwise treat each electronic message before delivery. These checks can include any number of processes, including scanning for malware (e.g., viruses, spyware, worms, and Trojan horses, among others), checking for spam, checking the contents of the message (e.g., keywords), and checking for specific senders or recipients, among others. Each of these process checks can include a number of distinct sub-processes. For example, a spam-checking process may need to apply multiple sub-processes, each of which check for spam in a different manner. Scanning for viruses can also include several processes, as can other checks not discussed in detail here. Although such servers are capable of processing at high speed, there are times when message delivery can be delayed because such servers become swamped with more messages to process than they can handle in a timely fashion at their present processing speed. This happens any time the rate of arrival exceeds the rate of departure for an extended period of time. This slowdown in processing can occur due to any number of different factors. Such slowdowns are problematic for users, who have become accustomed to relatively instantaneous delivery of electronic messaging in various forms, including e-mails, text messages, and the like.

To combat this typical problem, personnel manually monitor conventional electronic messaging systems and attempt to allocate messaging load to available hardware, such as messaging servers. If a particular message server is not functioning properly and cannot deliver messages, then the personnel can identify the problem and take the message server offline. This manual process is time consuming, as it requires that a person physically monitor the status of the message server and take it offline manually. Any messages in the queue at that server must then be manually rerouted to another message server for processing. This manual process is useful, but even if the time required to monitor, identify, and reroute messages is limited to hours, or even several minutes at minimum, these delays can prove to be problematic, particularly for the users whose message stream is interrupted.

Moreover, the act of taking a message server offline is disruptive to message delivery because it removes the capacity, however diminished, of the offline message server from the pool of message servers. Where a message server taken offline is able to function at partial capacity, for example, that partial capacity is a loss to the overall system. By removing this message server from the overall system, delivery is improved for the messages redistributed to other message servers. But the overall system now actually has less overall capacity. Moreover, removing, recovering, and re-adding the message server back to the system are operational steps that are costly and time consuming. As such, an intervention process that automatically ensured the delivery of messages while utilizing whatever usefulness is available in each message server, even those message servers functioning at partial capacity, would be useful.

In addition, often such messaging systems are laboring to maintain messaging flow because of large volumes of unwanted electronic messaging, or spam. Unwanted spam e-mail can account for over 95% of electronic mail traffic. Conventional systems treat all mail similarly, processing both unwanted mail and desirable mail in a first in, first out queue methodology. This methodology makes sense when all e-mail is desirable, as a user would prefer to receive e-mail in the order sent. But where each item of electronic messaging is not desirable, shifting any delivery delay to the undesirable electronic messaging, while maintaining more timely delivery of desirable electronic messaging, would be useful.

Unfortunately, such conventional electronic message delivery systems are unable to adequately maintain message delivery timeliness with such manual interventions and first in, first out queue methodologies.

### SUMMARY

The following simplified summary provides a basic overview of some aspects of the present technology. This summary is not an extensive overview. It is not intended to identify key or critical elements or to delineate the scope of this technology. This Summary is not intended to be used as an aid in determining the scope of the claimed subject matter. Its purpose is to present some simplified concepts related to the technology before the more detailed description presented below.

Accordingly, aspects of the invention automatically provide control of a message distribution process by monitoring the performance of a series of coordinated processes and by skipping those processes determined not to be processing properly. By skipping processes not processing properly, the message distribution process provides a way for maintaining messaging delivery timeliness. Aspects of the invention provide a way to automatically determine the performance of a message server and alter the flow of messages based upon the performance. By altering the flow of messages, message traffic is controlled and directed to well-performing message servers. Aspects of the invention provide for assigning addresses to a category and routing messages according to the categorization. By routing in this manner, messaging associated with categorized addresses is routed preferentially.

### BRIEF DESCRIPTION OF THE DRAWINGS

FIG. 1 depicts an exemplary system of one embodiment of the invention;

FIG. 2 is a flow diagram of a method of one embodiment of the invention;

FIG. 3 is a flow diagram of a method of another embodiment of the invention;

FIG. 4 is a flow diagram of a method of yet another embodiment of the invention;

FIG. 5 is a flow diagram of a method of still another embodiment of the invention; and

FIG. 6 is a flow diagram of a method of yet another embodiment of the invention.

Corresponding reference characters indicate corresponding parts throughout the drawings.

### DETAILED DESCRIPTION

### System

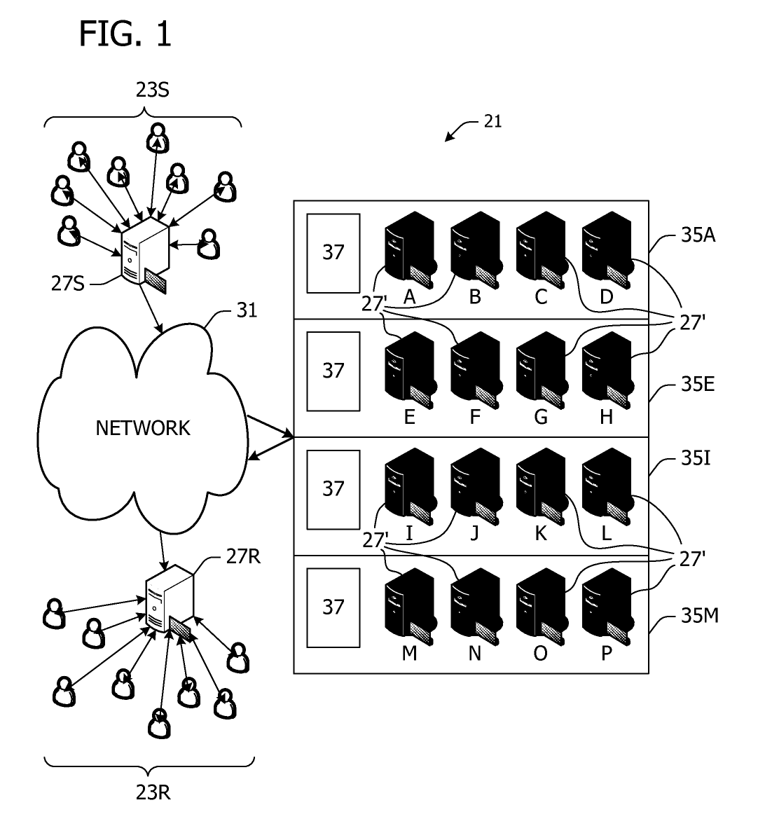

Referring now to FIG. 1, an exemplary message distribution system is generally indicated at 21. Such a system 21 is particularly useful in distributing items such as electronic mail, instant messaging, file transfer protocol, or telephony, to multiple users. In the exemplary embodiment shown, several users 23S (i.e., senders) wishing to communicate with other users 23R (i.e., recipients) send their communications to corresponding sender messaging servers 27S. The messaging servers 27S each communicate with a network 31, such as the World Wide Web, for communicating with other users (e.g., users 23R). The network 31 communicates with other messaging servers 27′ acting as message transfer agents, such as messaging servers A-P depicted in FIG. 1, which provide communication services to users 23R via the network 31 and recipient messaging servers 27R. Messaging servers A-P 27′ acting as message transfer agents are grouped into four data centers 35A, 35E, 351, and 35M, each of which comprises four messaging servers, A-D, E-H, I-L, and M-P, respectively. In the exemplary embodiment shown, each of the data centers 35 includes a load balancer 37 for distributing work between each of the message servers 27′. As would be understood by one skilled in the art, a single load balancer (e.g., GSLB (Global Server Load Balancing)) overseeing all of the data centers could also be used without departing from the scope of the embodiments of the present invention. Division of messaging servers 27′ between multiple data centers 35 is well known in the art and will not be discussed in detail here. Similarly, the relationship between the users 23S, 23R, the message servers 27S, 27R, 27′, and network 31 will not be discussed in greater detail here, as such a relationship would be readily appreciated by one skilled in the art. Also, the labeling of particular users 23 and message servers 27 as associated with “senders” or “recipients” above is merely for convenience in describing an example, as messages may be readily routed in both directions and between users both labeled “senders” or “recipients” with the same servers among the same users.

### Skipping Processes not Processing Properly

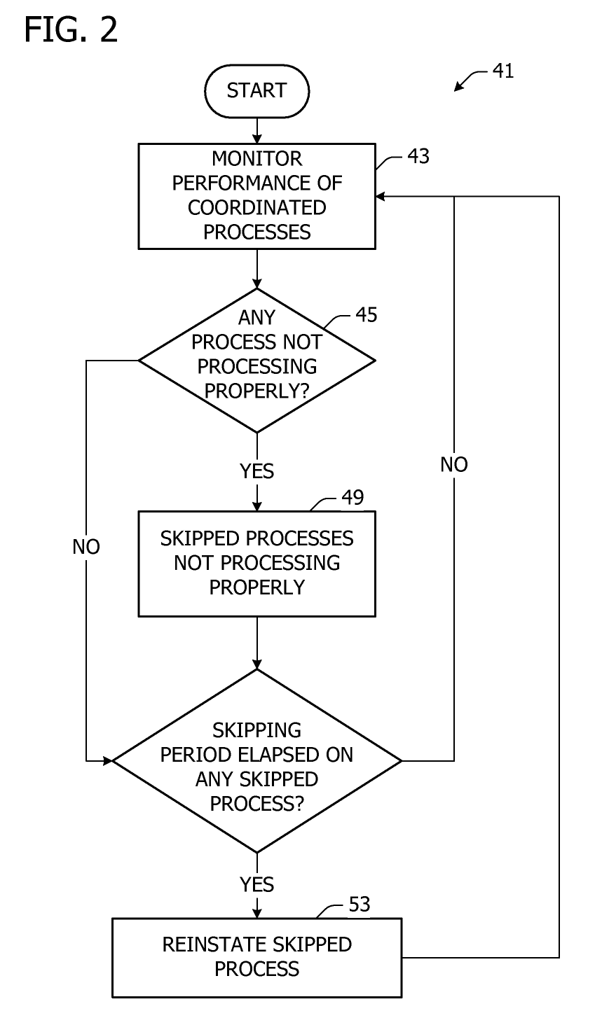

Referring now to FIG. 2, a method for controlling a message distribution process comprising a series of coordinated processes is generally indicated 41. Such coordinated processes can include any number of distinct processes coordinated with one another. For example, an electronic message routing process can perform routine checks (e.g., malware and spam, among others) on each routed electronic message. These process checks can include a number of distinct, sometimes coordinated, sub-processes. In an alternative embodiment, a spam-checking process may apply multiple sub-processes, each of which check for spam in a different manner. The present method 41 comprises monitoring, at 43, the performance of each of the series of coordinated processes.

The method 41 also comprises determining, at 45, that at least one of the monitored 43 series of coordinated processes is not processing properly. Such a process can lead to long delays in distribution and routing of electronic messaging, as message servers are either unable to process their messaging load fast enough, or are simply unable to process any more messages because the process stops of the particular process are not processing properly. Any number of tests may be utilized to determine 45 that a process, or more than one process, is not processing properly, as would be understood by one skilled in the art. In one exemplary embodiment, the determining 45 further comprises determining that at least one of the monitored series of coordinated processes is at least one of failing to process and processing for longer than a maximum time limit. In one alternative embodiment, a particular process taking 20 seconds to complete may exceed a maximum time limit of one second for that process. In addition, a process may fail to complete entirely, thereby slowing the message distribution process. According to still another exemplary embodiment, the determining 45 that at least one of the monitored series of coordinated processes is failing comprises determining that the at least one process has failed at least N times. For instance, the process may determine 45 that a process is not processing properly when the process has failed at least 10 times, such as with 10 different messages. As would be appreciated by one skilled in the art, any of the foregoing examples may be adjusted to include more or less stringent tests without departing from the scope of the exemplary embodiments of the present invention.

The method 41 additionally comprises skipping, at 49, the at least one of the monitored 43 series of coordinated processes that is determined 45 not to be processing properly. By skipping 49 the process, the message distribution process can continue to process electronic messaging without long message latency or a complete stoppage of the messaging process.

The method 41 further comprises reinstating, at 53, the at least one skipped 49 process after a skipping period has elapsed. The skipping period begins at the time the process was first skipped. In many cases, the process skipped 49 can process correctly after being reinstated later, such as when a message server 27 is experiencing a smaller amount of electronic messaging traffic. As would be understood by one skilled in the art, the method 41 continues monitoring 43 the active processes both before and after reinstating 53 the at least one skipped process.

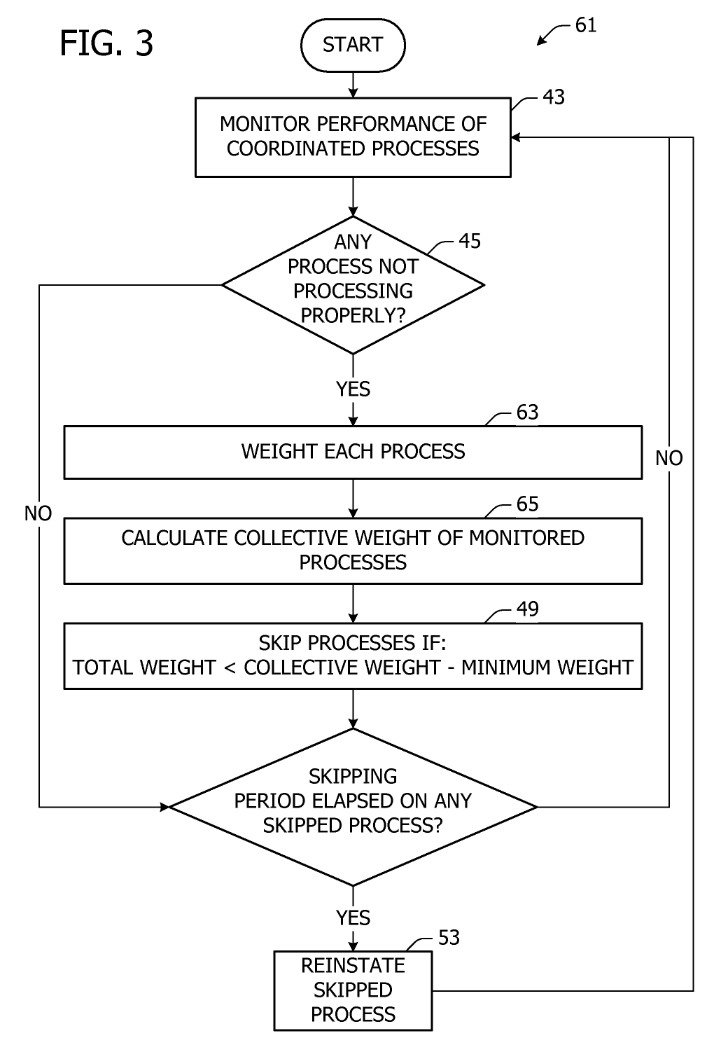

In another exemplary embodiment depicted in FIG. 3, a method similar to the method 41 of FIG. 2, is generally indicated 61. The method 61 comprises the monitoring 43, determining 45, skipping 49, and reinstating 53 processes generally as set forth above. The method 61 further comprises weighting, at 63, each of the processes of the monitored 43 series of coordinated processes and calculating, at 65, the collective weight of all the processes being monitored. Here, the skipping 49 comprises skipping only those processes having a total weight less than a difference between the collective weight and a minimum weight. For example, a malware scanning process might have five sub-processes, three of which having a weight of ten and two of which having a weight of five, for a collective weight of 40. Such a process might have a minimum weight of 25. Thus, if two processes each having a weight of five are determined 45 not to be processing properly, then those processes may be skipped because their combined weight of ten is less than the difference of 15 between the collective weight (40) and the minimum weight (25). But if two processes each having a weight of ten are determined 45 not to be processing properly, then only one of those processes may be skipped because their combined weight of twenty is not less than the difference of 15 between the collective weight (40) and the minimum weight (25). The weighting 63 ensures that the skipping 49 does not remove too many sub-processes, so that the process itself becomes less effective, for example. As would be understood by one skilled in the art, the minimum weight and weight of each sub-process may be adjusted to limit or liberalize the amount skipping that may occur with respect to each process. In this manner, one skilled in the art can readily control the importance and relative amount of skipping available for each process.

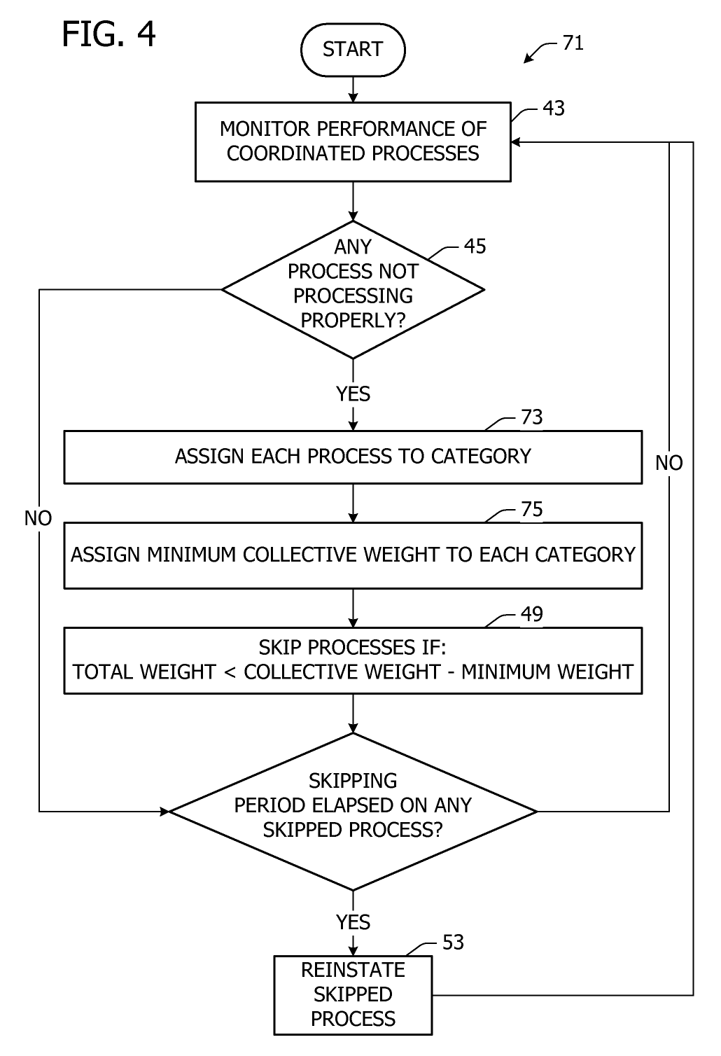

In still another exemplary embodiment depicted in FIG. 4, a method similar to the method 41 of FIG. 2, is generally indicated 71. The method 71 comprises the monitoring 43, determining 45, skipping 49, and reinstating 53 processes generally as set forth above. The method 71 further comprises assigning, at 73, each of the processes to a category and assigning, at 75, a minimum collective weight to each of the categories. Here, the skipping 49 comprises skipping a process only when the process has a weight less than the difference between a collective weight of the processes in its category currently being processed and a minimum collective weight for the category. In one alternative embodiment, a message distribution process may include both malware scanning and spam detection processes. The malware scanning process might have five sub-processes, each with a weight of 10, while the spam detection has ten sub-processes, each with a weight of ten. Each of these processes is assigned 73 to a category, namely: malware or spam. Next, a minimum collective weight is assigned 75 to each category. In this example, the malware category is assigned a minimum collective weight of 38, while the spam category is assigned a minimum weight of 55. Thus, only one of the five malware sub-processes may be skipped, as skipping two sub-processes would bring the malware collective weight to 30, which is less than 38. Alternately, the method 71 may skip up to four of the ten spam sub-processes, as skipping four sub-processes would bring the spam collective weight to 60, which is greater than 55. As would be understood by one skilled in the art, this example places a higher value on maintaining malware sub-processes than on maintaining spam sub-processes. As would also be understood by one skilled in the art, the minimum weight and the weight of each sub-process may be adjusted to limit or liberalize the amount of skipping that may occur with respect to each process category. In this manner, one skilled in the art can readily control the importance and relative amount of skipping available for each category of sub-process.

### Controlling Message Traffic Based Upon Performance

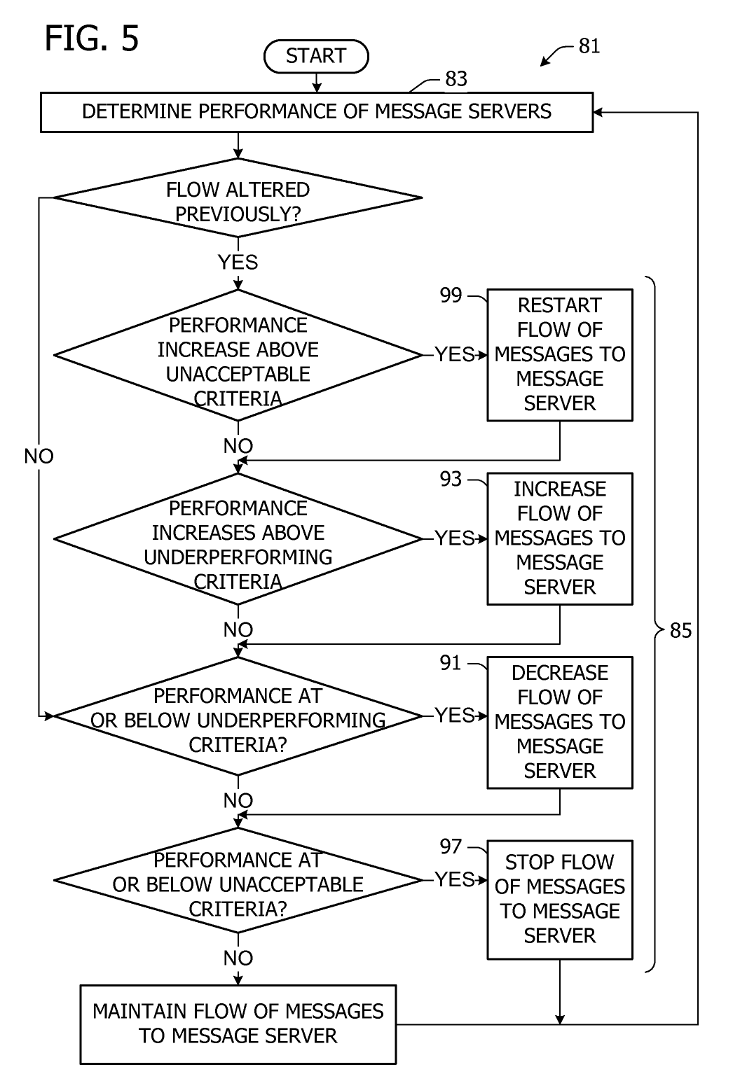

Referring now to FIG. 5, a method for controlling the load of message traffic processed by two or more message servers is generally indicated at 81. The method comprises determining, at 83, the performance of at least one of the two or more message servers 27′. For example, determining 83 the performance of a message server 27′ can comprise at least one of determining the number of messages currently being processed by the message server, the latency of the messages in making a call, the latency of the queue of messages, the length of time a single message takes to be processed by the message server, the number of steps the message server skips in processing the messages, the number of crashes realized by the message server, the number of faults realized by the message server, and the amount of memory being consumed by the message server. Other processes for determining 83 the performance of at least one of the two or more message servers 27′ are also contemplated as within the scope of embodiments of the present invention.

The method 81 further comprises altering, generally indicated at 85, without user intervention, the flow of messages to the at least one message server 27′ based upon the determined 83 performance. As used herein, the phrase “without user intervention” is defined as those actions undertaken automatically, without the influence of a human actor at the time of action. For example, a command undertaken by a computing device based upon stored instructions, but without additional instructions or initialization by a user is an operation occurring without user intervention. In one exemplary embodiment, altering 85 the flow of messages to the at least one message server 27′ comprises enabling, also at 85, a load balancer to alter the flow of messages based upon the determined performance without user intervention. For example, the method can enable a load balancer, without user intervention, to allocate the flow of messages among two or more data centers 35, each comprising two or more message servers 27′, based upon the determined performance. In still another alternative embodiment, the method 81 can enable a load balancer, also at 85, to allocate the flow of messages among the two or more data centers 35 without user intervention, such that each of the data centers exhibits substantially the same overall performance. In these alternative embodiments, the method 81 is applying the electronic messaging load to the data centers according to their performance, thereby maximizing the total output of all the data centers combined. For example, taking the system 21 of FIG. 1, assume that it is determined that three data centers 35A, 35E, and 351 are each highly performing, while a fourth data center 35M is not performing well. In this instance, the total system output may be increased by allocating a portion of the flow from the underperforming fourth data center 35M to each of the three highly performing data centers 35A, 35E, and 351. By removing a portion of the workload from the underperforming data center 35M, its performance will increase. Conversely, adding this workload to the highly performing data centers will decrease their performance. Overall, by altering 85 the flow of electronic messaging according to the determined performance, the data centers can be made to exhibit substantially the same overall performance, as measured in some common measure like message latency, which increases the overall efficiency of the electronic messaging distribution process. In other words, overall efficiency can be increased by overburdening the overperforming data centers and underburdening the underperforming data centers so that the data centers distribute messages with similar latency, albeit with different levels of total message throughput. Although the example discussed above is relatively simple, one skilled in the art would readily understand that the flow of electronic messaging could be altered among multiple data centers with varying levels of performance without departing from the scope of embodiments of the present invention.

In yet another exemplary embodiment, altering 85 the flow of messages to the at least one message server 27′ comprises enabling a load balancer, without user intervention, to allocate the flow of messages among the two or more message servers based upon the determined performance. In another embodiment, the method 81 can enable a load balancer to allocate the flow of messages among the two or more message servers 27′ without user intervention, such that each of the message servers exhibit substantially the same overall performance. This embodiment is similar to the embodiment discussed immediately above, except that the previous embodiment allocated the flow of messages among the two or more data centers 35, while this embodiment allocates the flow of messages among two or more message servers 27′.

In still another embodiment, the altering 85 the flow of messages to the at least one message server 27′ comprises changing the flow of messages to the message server when the determined 83 performance meets a performance criteria. In one example, altering 85 the flow of messages to the at least one message server 27′ comprises decreasing, at 91, the flow of messages to the message server when the determined 83 performance is at or below an underperforming criteria. In this manner, a message server 27′ that is underperforming receives a decrease in message flow so that it is more capable of handling its message flow. In another alternative embodiment, altering 85 the flow of messages to the at least one message server 27′ further comprises increasing, at 93, the flow of messages to the message server when the determined 83 performance increases from at or below the underperforming criteria to above the underperforming criteria. In this manner, as performance of the message server 27′ increases, the flow of electronic messaging to the server can also be increased. In still another alternative embodiment, altering 85 the flow of messages to the at least one message server 27′ comprises stopping, at 97, the flow of messages to the message server when the determined performance is at or below an unacceptable criteria. In this manner, if the performance of the message server 27′ drops to an unacceptable level, all message flow to the message server stops, whereby the message server has an opportunity to process its current backlog of messages. In yet another alternative embodiment, altering 85 the flow can further comprise restarting, at 99, the flow of messages to the message server 27′ when the determined performance increases from at or below the unacceptable criteria to above the unacceptable criteria. In this manner, as performance of the message server 27′ increases, the flow of electronic messaging to the server restarts. With these different means for altering 85 the flow of electronic messaging, the method 81 can effectively balance the load of electronic messaging to increase overall performance of the system 21.

### Routing Messages According to Message Category

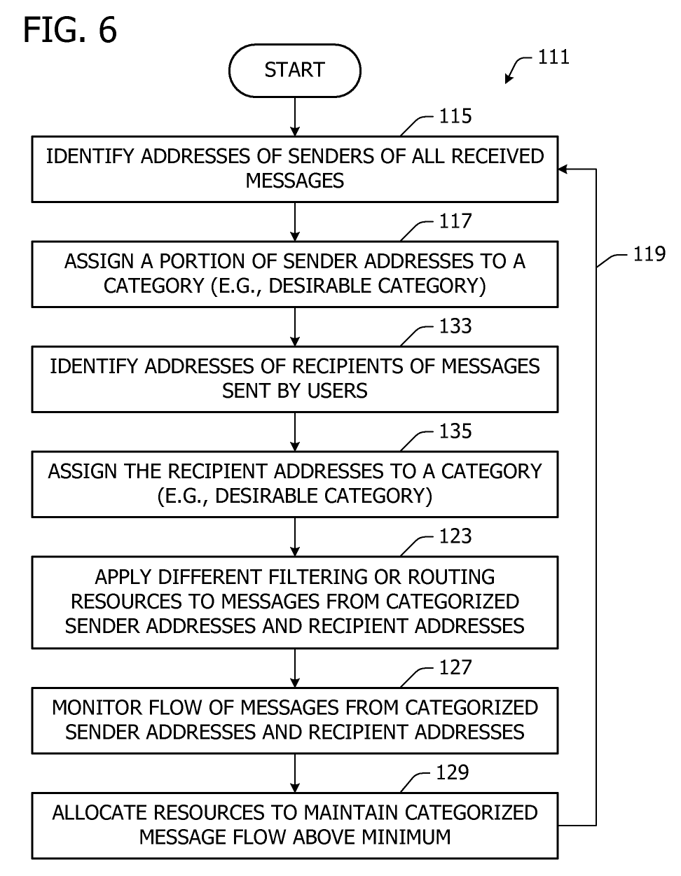

Referring now to FIG. 6, a method for routing messages through message routing resources according to the party associated with the message is generally depicted as 111. The method comprises identifying, at 115, the addresses (e.g., IP (Internet Protocol) addresses) of senders of all messages received by a set of users within a period (e.g., 30 days).

The method 111 further comprises assigning, at 117, at least a portion of the identified sender addresses to a category. In one exemplary embodiment, the assigning 117 comprises assigning at least a portion of the identified sender addresses to a category according to their desirability as a sender. For example, the assigning 117 can comprise assigning sender addresses of those senders who sent at least N number of messages that no recipient identified as undesirable in a desirable category. Such a test facilitates identifying desirable, non-spam, electronic messaging because the number of messages indicates a high level of communication and the lack of any indication by any recipient that these messages are undesirable normally indicates a highly desirable message. In another exemplary embodiment, the assigning 117 can comprise assigning sender addresses to a category according to a category nomination by one or more recipients. Other forms of data mining (e.g., traffic volume, previously sent messages, etc.) may also be utilized to identify those addresses that should be categorized.

The method 111 further comprises repeating, at 119, the identifying 115 and assigning 117 periodically to revise the categorization of identified sender addresses.

The method 111 further comprises routing, at 123, messages from the identified sender addresses assigned to a category through the message routing resources according to their assigned category. In one exemplary embodiment, routing 123 messages further comprises routing messages from sender addresses assigned to the desirable category through at least one of a different filtering process and a different message routing resource than messages from sender addresses not assigned to the desirable category. For example, the routing 123 messages from sender addresses assigned to the desirable category through at least one of a different filtering process and a different routing resource can comprise routing such messages through at least one of a less rigorous filtering process and one or more message routing resources dedicated to deliver only such messages. For example, one or more message routing resources, such as the first data center 35A in FIG. 1, may be dedicated to deliver only such categorized messages. By allocating specific system routing resources (e.g., a data center or message server) to only messages from categorized senders, the timely delivery of such categorized messages is assured. In one example, such categorized messages are determined to be of higher importance because they are from known senders.

In another exemplary embodiment, the routing messages further comprises monitoring, at 127, the flow of messages from sender addresses assigned to the desirable category and allocating, at 129, routing resources such that the flow of messages from sender addresses assigned to the desirable category remains above a minimum flow threshold. Here, message flow is monitored to ensure that messages from categorized users, which have been determined to be more important than other messages, remains above a minimum flow threshold. If the message flow does not remain above the minimum flow threshold, the method 111 allows for allocating resources to increase flow. For example, assume the first data center 35A of FIG. 1 is dedicated to processing only messages associated with the categorized addresses. If this data center 35A is having difficulty maintaining the flow of such messages, the method 111 allows for the allocation of additional resources, such as one or more message servers 27′ from another data center (e.g., 35E, 35I, and 35M), to the task of processing messages associated with the categorized addresses. In this manner, such messages are processed promptly, while other messages from non-categorized are handled with the bulk of electronic messaging, which can be subject to greater latency.

In one exemplary embodiment, the method 111 may further comprise identifying, at 133, the addresses of recipients of all messages sent by a set of users and assigning, at 135, each of the identified recipient addresses to the desirable category. This exemplary method may further comprise routing, at 123, messages from sender addresses and recipient addresses assigned to the desirable category through at least one of a different filtering process and a different message routing resource than messages from sender addresses not assigned to the desirable category. In addition to identifying senders, this portion of the method 111 also identifies 133 recipients and assigns 135 them to the desirable category.

Those skilled in the art will note that the order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products and methods without departing from the scope of the embodiments of the invention, it is intended that all matter contained in the above description and shown in the accompanying drawings shall be interpreted as illustrative and not in a limiting sense.

What is claimed is:

1. A method for controlling a message distribution process comprising a series of coordinated processes, said method comprising:
monitoring the performance of each of said series of coordinated processes;
determining that at least one of said monitored series of coordinated processes is not processing properly;
skipping said at least one of said monitored series of coordinated processes that is determined not to be processing properly.

2. A method as set forth in claim 1 wherein said determining that at least one of said monitored series of coordinated processes is not processing properly comprises determining that at least one of said monitored series of coordinated processes is at least one of failing to process and processing for longer than a maximum time limit.

3. A method as set forth in claim 1 further comprising reinstating said at least one skipped process after a skipping period has elapsed, said skipping period beginning at the time the process was first skipped.

4. A method as set forth in claim 1 further comprising:
weighting each of said processes of said monitored series of coordinated processes;
calculating the collective weight of all the processes being monitored, wherein said skipping comprises skipping only those processes having a total weight less than a difference between the collective weight and a minimum weight;
assigning each of said processes to a category; and
assigning a minimum collective weight to each of said categories, wherein said skipping comprises skipping a process only when said process has a weight less than the difference between a collective weight of the processes in its category currently being processed and a minimum collective weight for the category.

5. A method for controlling the load of message traffic processed by two or more message servers, said method comprising:
determining the performance of at least one of said two or more message servers; and
altering the flow of messages to the at least one message server based upon the determined performance without user intervention.

6. A method as set forth in claim 5 wherein said altering the flow of messages to the at least one message server comprises enabling a load balancer to alter the flow of messages based upon said determined performance without user intervention.

7. A method as set forth in claim 6 wherein said altering the flow of messages to the at least one message server comprises enabling a load balancer to allocate the flow of messages among two or more data centers, each comprising two or more message servers, based upon said determined performance without user intervention, such that each of the data centers exhibits substantially the same overall performance.

8. A method as set forth in claim 6 wherein said altering the flow of messages to the at least one message server comprises enabling a load balancer to allocate the flow of messages among the two or more message servers based upon said determined performance without user intervention, such that each of the message servers exhibits substantially the same overall performance.

9. A method as set forth in claim 5 wherein said altering the flow of messages to the at least one message server comprises changing the flow of messages to the message server when the determined performance meets a performance criteria.

10. A method as set forth in claim 9 wherein said altering the flow of messages to the at least one message server comprises decreasing the flow of messages to the message server when the determined performance is at or below an underperforming criteria.

11. A method as set forth in claim 10 wherein said altering the flow of messages to the at least one message server further comprises increasing the flow of messages to the message server when the determined performance increases from at or below the underperforming criteria to above the underperforming criteria.

12. A method as set forth in claim 10 wherein said altering the flow of messages to the at least one message server comprises stopping the flow of messages to the message server when the determined performance is at or below an unacceptable criteria and restarting the flow of messages to the message server when the determined performance increases from at or below the unacceptable criteria to above the unacceptable criteria.

13. A method as set forth in claim 5 wherein said determining the performance of a message server comprises at least one of determining the number of messages currently being processed by the message server, the latency of the messages in making a call, the latency of the queue of messages, the length of time a single message takes to be processed by the message server, the number of steps the message server skips in processing the messages, the number of crashes realized by the message server, the number of faults realized by the message server, and the amount of memory being consumed by the message server.

14. A method for routing messages through message routing resources according to the party associated with the message, said method comprising:
identifying the addresses of senders of all messages received by a set of users within a time period;
assigning at least a portion of the identified sender addresses to a category; and
routing messages from said identified sender addresses assigned to a category through the message routing resources according to their assigned category.

15. A method as set forth in claim 14 wherein said assigning comprises assigning at least a portion of the identified sender addresses to a category according to their desirability as a sender.

16. A method as set forth in claim 15 wherein said assigning at least a portion of the identified sender addresses to a category comprises assigning sender addresses of those senders who sent at least N number of messages that no recipient identified as undesirable in a desirable category.

17. A method as set forth in claim 16 wherein said routing messages further comprising routing messages from sender addresses assigned to the desirable category through at least one of a different filtering process and a different message routing resource than messages from sender addresses not assigned to the desirable category.

18. A method as set forth in claim 17 wherein said routing messages further comprises monitoring the flow of messages from sender addresses assigned to the desirable category; and
allocating routing resources such that the flow of messages from sender addresses assigned to the desirable category remains above a minimum flow threshold

19. A method as set forth in claim 17 wherein said routing messages from sender addresses assigned to the desirable category through at least one of a different filtering process and a different routing resource comprises routing such messages through at least one of a less rigorous filtering process and one or more message routing resources dedicated to deliver only such messages.

20. A method as set forth in claim 16 further comprising identifying the addresses of recipients of all messages sent by a set of users;
assigning each of the identified recipient addresses to the desirable category; and
routing messages from sender addresses and recipient addresses assigned to the desirable category through at least one of a different filtering process and a different message routing resource than messages from sender addresses not assigned to the desirable category.
